(19) United States
(12) Patent Application Publication
(10) Pub. No.: US 2015/0319172 A1
(43) Pub. Date: Nov. 5, 2015

(54) GROUP AUTHENTICATION AND KEY MANAGEMENT FOR MTC

(71) Applicant: NEC CORPORATION, Minato-ku, Tokyo (JP)

(72) Inventors: Xiaowei ZHANG, Tokyo (JP); Anand Raghawa PRASAD, Tokyo (JP)

(21) Appl. No.: 14/648,798

(22) PCT Filed: Dec. 4, 2013
(86) PCT No.: PCT/JP2013/083274

§ 371 Date: Jun. 1, 2015

(30) Foreign Application Priority Data
Dec. 6, 2012 (JP) 2012-267255

(51) Int. Cl. H04L 29/06; H04W 12/06; H04W 12/04

(52) U.S. Cl. CPC H04L 63/0869; H04L 63/065; H04W 12/04; H04W 12/06

(57) ABSTRACT

An SCS (60) sends out a trigger message for activating a group of MTC devices (10_{—}1 to 10_{—}n) through a network. An HSS (40) verifies whether or not to transfer the trigger message to the given MTC devices (10_{—}1 to 10_{—}n) based on subscription information of the group. A group GW (20) broadcasts the trigger message. Further, An MME (30) concatenates DL (downlink) messages addressed to the MTC devices (10_{—}1 to 10_{—}n). The group GW (20) distributes, to the MTC devices (10_{—}1 to 10_{—}n), the DL messages included in the concatenated message. Furthermore, the group GW (20) concatenates UL (uplink) messages received from the MTC devices (10_{—}1 to 10_{—}n). The MME (30) processes the UL messages included in the concatenated message.

### TECHNICAL FIELD

The present invention relates to a security solution for group authentication in Machine-Type Communication (MTC). This solution can provide an efficient way for network to perform mutual authentication with all the group MTC UEs (User Equipments).

### BACKGROUND ART

The 3GPP (3rd Generation Partnership Project) architecture of MTC is disclosed in NPL 1. The AKA (Authentication and Key Management) procedure disclosed in NPL 2 can be performed individually to achieve mutual authentication.

### CITATION LIST

### Non Patent Literature

NPL 1: 3GPP TS 23.682, “Architecture enhancements to facilitate communications with packet data networks and applications (Release 11)”, V11.2.0, 2012-09

NPL 2: 3GPP TS 33.401, “3GPP System Architecture Evolution (SAE); Security architecture (Release 12)”, V12.5.1, 2012-10

NPL 3: 3GPP TR 33.868, “Security aspects of Machine-Type and other Mobile Data Applications Communications Enhancements; (Release 12)”, V0.10.0, 2012-09

### Patent Literature

PTL 1: International Patent Publication No. WO 2012/018130

### SUMMARY OF INVENTION

### Technical Problem

However, inventors of this application have found that there are few issues for MTC UEs as follows:

1) Authentication happens at the same time can overload the network.

2) MTC UE needs to have mutual authentication to the network not only as an individual but also as a group member. The security requirement has been disclosed in NPL 3: “UE can be verified as legitimate member of a MTC group”.

3) New keys are needed for securing group messaging.

The solution proposed in this invention is focused on will be described in the following sections.

### Solution to Problem

A few assumptions are made for the present invention as follows:

1) SCS (Service Capability Server) knows the external group ID (identifier) and can use it to activate a group and communicate with the group of MTC UEs.

2) MTC UEs are preconfigured with the group ID(s) that they can belong to and communicate through.

3) MTC UEs are optionally preconfigured with a public group key.

Note, in the description of this invention, MME (Mobility Management Entity) is used as an example but the mechanism should be the same for SGSN (Serving GPRS (General Packet Radio Service) Support Node) and MSC (Mobile Switching Centre).

When the SCS first time actives a group of MTC UEs, it triggers the UEs by sending a trigger message with indication of trigger.type=“activate group”. When MTC-IWF (MTC Inter-Working Function) receives such type of trigger it will request subscriber information from HSS (Home Subscriber Server) by sending Subscriber Information Request. HSS will perform verification of whether such group exists and whether it can be triggered by the SCS and finds which are the possible MMEs. HSS pushes the routing information of MMEs to MTC-IWF, MTC-IWF will then forward the trigger to the serving MMEs. MME forwards it to group GW (gateway) and group GW broadcasts it to the UEs. The trigger contains local group ID and trigger ID. Only UEs which preconfigured the same group ID should respond to it and start the Attach procedure.

Since this is first time UE attaches to network, AKA procedure will be started by network. The concept is to re-use AKA procedure disclosed in NPL 2. However, instead of authenticating the UE individually, MME sends all the authentication request in a concatenated message and group GW distributes that to UEs. In the same way for Authentication Response, group GW receives them from all the UEs and sends them in a concatenated message to MME. By doing this, the network usage can be reduced.

Verification of whether UE belongs to this group is carried at network before authentication.

The group gateway (GW) was proposed in a separate invention of PTL 1. The group GW receives (group) message and send it to MTC devices. It sends concatenated messages for MTC device communicating with network or SCS. It can be an independent node or a logical function installed in eNB (evolved Node B), MME/SGSN/MSC, HSS or MTC-IWF. When it is installed in eNB, broadcasting is used for sending messages to UEs. When it is installed in MME/SGSN/MSC, multicasting is used. Note that each of the MTC Device and the above-described MTC UE is a UE equipped for MTC, therefore the terms “MTC Device” and “MTC UE” are the same in meaning through the whole description of this application.

### Advantageous Effects of Invention

According to the present invention, it is possible to solve at least one of the above-mentioned issues.

### BRIEF DESCRIPTION OF DRAWINGS

FIG. 1 is a block diagram showing a configuration example of a communication system according to an exemplary embodiment of the present invention.

FIG. 2 is a sequence diagram showing a part of an operation example of the communication system according to the exemplary embodiment.

FIG. 3 is a sequence diagram showing the remaining part of the operation example of the communication system according to the exemplary embodiment.

FIG. 4 is a block diagram showing a configuration example of an MTC device according to the exemplary embodiment.

FIG. 5 is a block diagram showing a configuration example of a gateway according to the exemplary embodiment.

FIG. 6 is a block diagram showing a configuration example of a first network node according to the exemplary embodiment.

FIG. 7 is a block diagram showing a configuration example of a second network node according to the exemplary embodiment.

FIG. 8 is a block diagram showing a configuration example of a third network node according to the exemplary embodiment.

FIG. 9 is a block diagram showing a configuration example of a server according to the exemplary embodiment.

### DESCRIPTION OF EMBODIMENTS

Hereinafter, an exemplary embodiment of the present invention will be described with reference to the accompanying drawings.

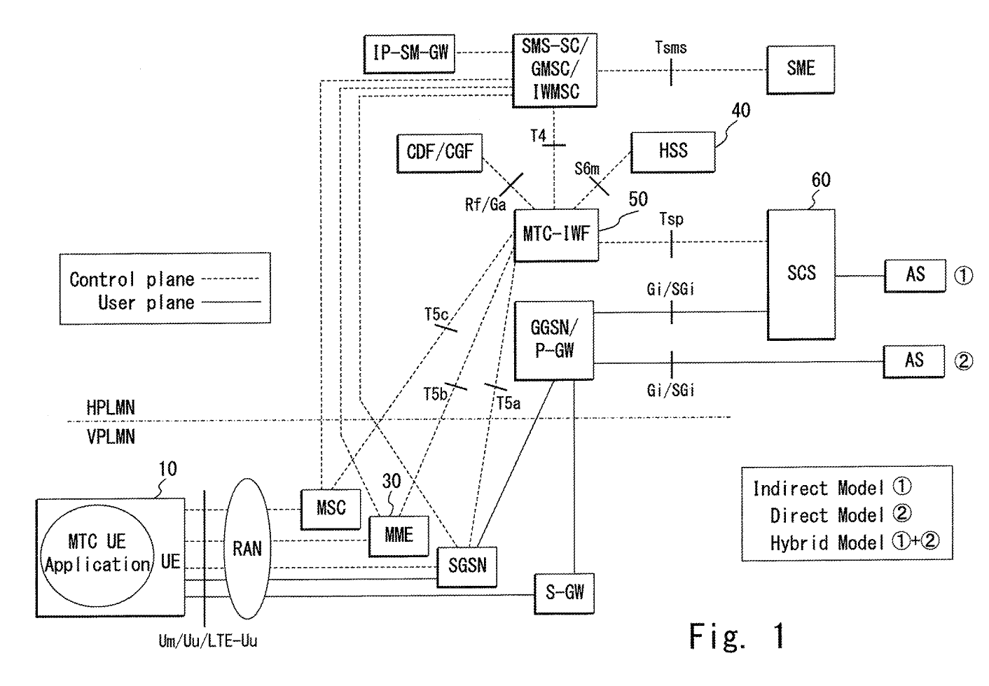

As shown in FIG. 1, a communication system according to this exemplary embodiment includes a core network (3GPP network), and a plurality of MTC UEs 10 which connect to the core network through a RAN (Radio Access Network). While the illustration is omitted, the RAN is formed by a plurality of base stations (i.e., eNBs).

The MTC UEs 10 attach to the core network. The MTC UEs 10 can host one or multiple MTC Applications. The corresponding MTC Applications are hosted on one or multiple ASs (Application Servers).

Further, the core network includes, as network elements, an MME 30, an HSS 40 and an MTC-IWF 50. The MTC-IWF 50 serves as a gateway to the core network for an SCS 60. The HSS 40 stores subscription information on a group of MTC UEs. The MME 30, as well as an SGSN and an MSC relay traffic between the MTC UEs 10 and the MTC-IWF 50.

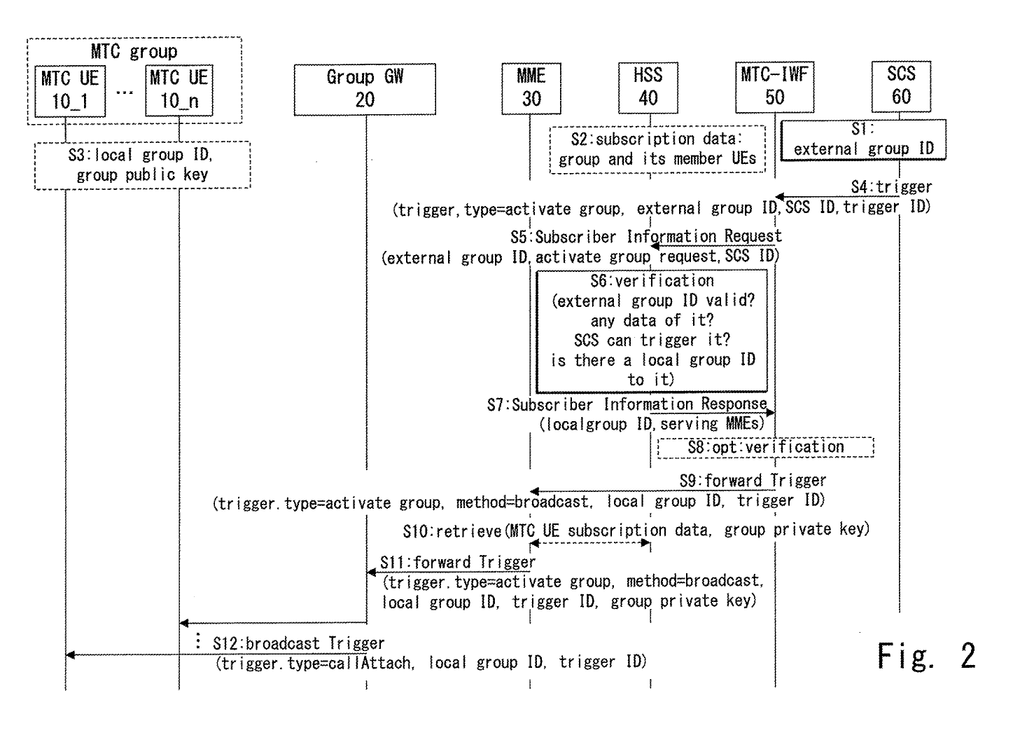

Furthermore, a group GW 20 shown in FIGS. 2 and 3 serves as a gateway to the core network for the MTC UEs 10. The group GW 20 may be an independent node placed within the core network or the RAN, or may be a logical function installed in the eNB, MME, SGSN, MSC, HSS or MTC-IWF.

Next, operations in this exemplary embodiment will be described with reference to FIGS. 2 and 3. FIGS. 2 and 3 gives detailed message sequence description of how the SCS 60 activates a group of devices (MTC UEs) which are pre-configured with a local group ID.

Step S1: SCS 60 has stored the external group ID.

Step S2: HSS 40 has subscription information of a group and its member UEs 10_1 to 10_{—}n (n≧2).

Step S3: Each of UEs 10_1 to 10_{—}n in the group has pre-configured local group ID and optionally public group key.

Step S4: SCS 60 sends a trigger to MTC-IWF 50, with trigger type of activate group, including external group ID, SCS ID and trigger ID.

Step S5: MTC-IWF 50 sends Subscriber Information Request, reuse the message disclosed in NPL 1, with external group ID, indication of activate group request and the source SCS ID.

Step S6: HSS 40 performs the verification of whether the external group ID is valid, whether any data available about this group, if SCS can trigger to activate the group, is there already a local group ID mapped to it.

Step S7: After proper verification, HSS 40 sends the Subscriber Information Response message to MTC-IWF 50, with local group ID and serving MMEs.

Step S8: Optionally, HSS 40 can send information necessary for the verification and MTC-IWF 50 performs the verification.

Step S9: MTC-IWF 50 forwards the trigger message to MME 30, with local group ID and trigger method of broadcast.

Step S10: MME 30 retrieves the MTC UE subscription data and the private group key.

Step S11: MME 30 forwards the trigger to group GW 20.

Step S12: Group GW 20 broadcast the trigger, with a trigger type of e.g. callAttach, which UEs 10_1 to 10_{—}n can understand. The trigger includes local group ID and trigger ID.

Step S13: When each of UEs 10_1 to 10_{—}n receives the trigger, it verifies if the local group ID in the broadcast trigger is the same with the one it has pre-configured. If not, it ignores the broadcast. If the group ID is the same, each of UEs 10_1 to 10_{—}n starts the attach procedure.

Step S14: UEs 10_1 to 10_{—}n which have the same local group ID send Attach Request with IMSI as in standardized Attach Request and also the trigger ID it received.

Step S15: Group GW 20 sends a concatenated Attach Request to MME 30, it contains the Attach Request messages from all the UEs.

Step S16: MME 30 performs the verification of whether the timer of response is expired, whether the UEs whom responded belong to the group and which are the UEs have not responded yet.

Step S17: MME 30 sends Authentication Request (reusing standardized message disclosed in NPL 2, but in a concatenated message.

Step S18: Group GW 20 distributes the Authentication Request to the UEs 10_1 to 10_{—}n, this can be optionally protected by private group key such that UEs 10_1 to 10_{—}n can verify whether the group GW 20 is an authenticated network element, with their pre-configured public group key.

Step S19: Each of UEs 10_1 to 10_{—}n responds Authentication Response.

Step S20: Group GW 20 sends Authentication Response from all the UEs 10_1 to 10_{—}n in a concatenated message.

Step S21: MME 30 performs authentication for the UEs 10_1 to 10_{—}n.

Step S22: MME 30 sends Authentication Reject messages to UE, if the authentication failed.

Steps S23 and S24: MME 30 reports authentication failure to SCS 60 through MTC-IWF 50.

Step S25: NAS (Non Access Stratum) and AS key management according to standardized procedure disclosed in NPL 2, with MME 30 sending the concatenated message and group GW 20 distributing it to UEs 10_1 to 10_{—}n for downlink and group GW 20 concatenating the messages from UEs 10_1 to 10_{—}n and sending to MME 30 for uplink.

Step S26a: MME 30 sends NAS SMC (Security Mode Command) messages in concatenated message which includes the new group keys encrypted by NAS key.

Step S26b: Group GW 20 distributes the NAS SMC message containing encrypted new group keys to the UEs 10_1 to 10_{—}n.

Step S27a: MME 30 sends Attach Accept messages in concatenated message which includes the new group keys.

Step S27b: Group GW 20 distributes the Attach Accept message with new group keys to the UEs 10_1 to 10_{—}n.

Note that the new group keys in Step S26 and Step S27 are the same as in our previous patent file PTL 1, that they are a pair of keys for confidentiality and integrity protection.

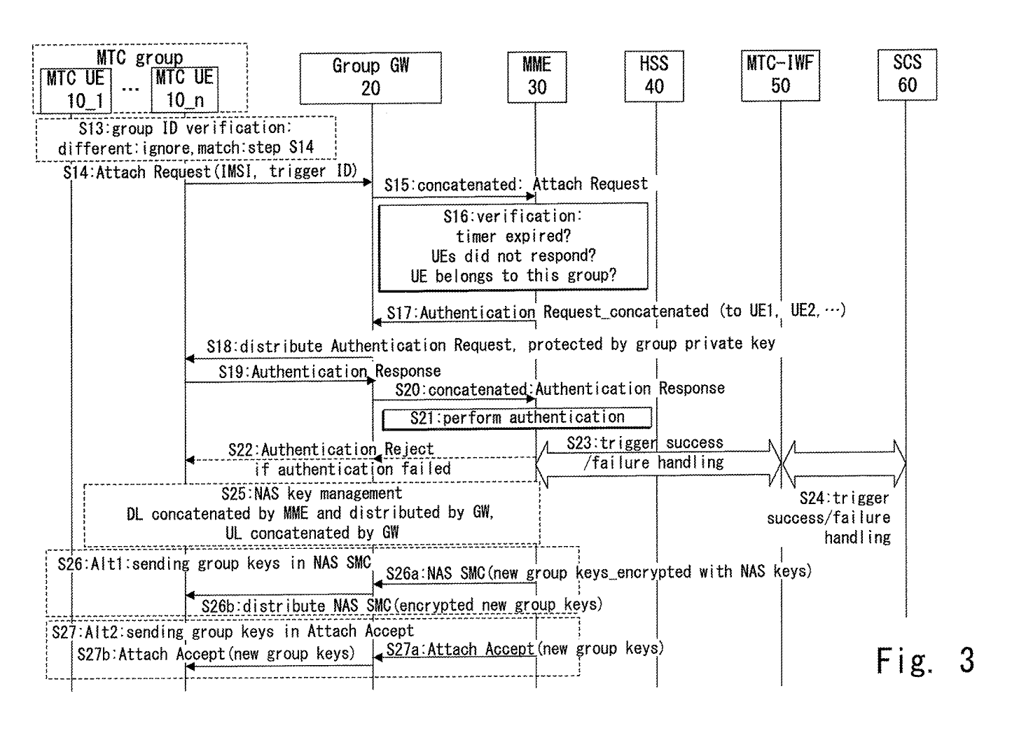

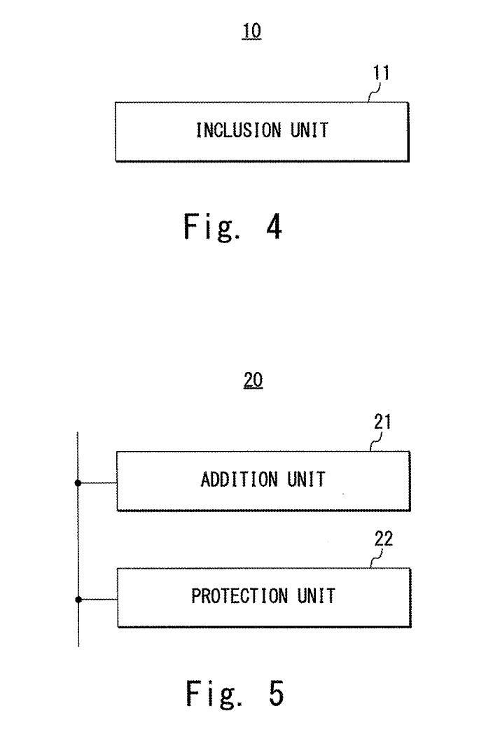

Next, configuration examples of the MTC UE 10, the group GW 20, the MME 30, the HSS 40, the MTC-IWF 50 and the SCS 60 according to this exemplary embodiment will be described with reference to FIGS. 4 to 9. Note that in the following explanation, there will be described only elements which specific to this exemplary embodiment. However, it will be understood that the MTC UE 10, the group GW 20, the MME 30, the HSS 40, the MTC-IWF 50 and the SCS 60 also include elements for functioning as typical MTC UE, GW, MME, HSS, MTC-IWF and SCS, respectively.

As shown in FIG. 4, the MTC UE 10 includes an inclusion unit 11. The inclusion unit 11 includes the received trigger ID in the Attach Request message as shown at step S14 in FIG. 3. This inclusion unit 11 can be configured by, for example, a transceiver which conducts communication with the SCS 60 through the core network, and a controller such as a CPU (Central Processing Unit) which controls this transceiver.

As shown in FIG. 5, the group GW 20 includes at least one of an addition unit 21 and a protection unit 22. The addition unit 21 adds the indication of trigger type=“callAttach” to the trigger message as shown at step S12 in FIG. 2. The protection unit 22 protects the Authentication Request message with the private group key as shown at step S18 in FIG. 3. Note that these units 21 and 22 are mutually connected with each other through a bus or the like. These units 21 and 22 can be configured by, for example, a transceiver which conducts communication with the MTC UE 10, and a controller such as a CPU which controls this transceiver.

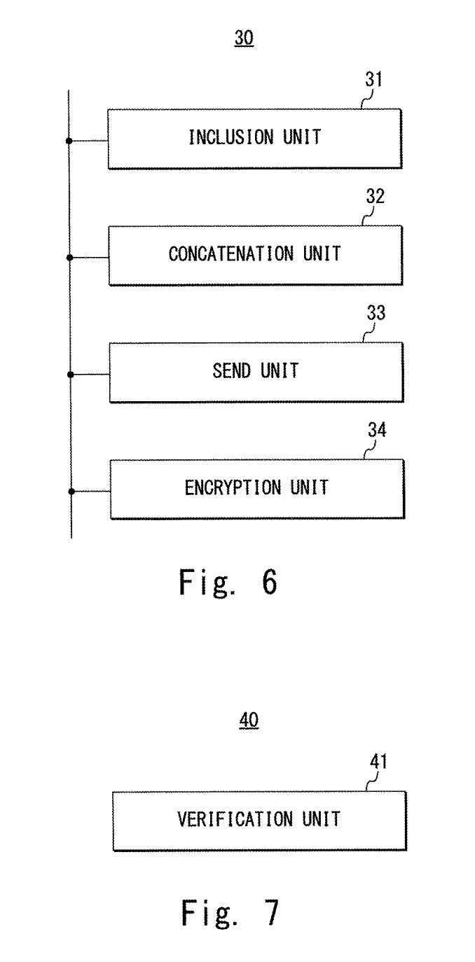

As shown in FIG. 6, the MME 30 includes at least an inclusion unit 31. For example, the inclusion unit 31 includes the new group keys in the Attach Accept message as shown at step S27 in FIG. 3. Alternatively, the inclusion unit 31 includes the new group keys in the NAS SMC message as shown at step S26 in FIG. 3. In the latter case, it is preferable that the MME 30 further includes an encryption unit 34. The encryption unit 34 encrypts the new group keys with the NAS keys. In addition to or as a substitute for the encryption unit 34, the MME 30 can include a concatenation unit 32 and a send unit 33. The concatenation unit 32 concatenates the messages addressed to the MTC UEs 10_1 to 10_{—}n as shown at Steps S17 and S25 in FIG. 3. The send unit 33 sends the concatenated message to the group GW 20. Note that these units 31 to 34 are mutually connected with each other through a bus or the like. These units 31 to 34 can be configured by, for example, a transceiver which conducts communication with the MTC UE 10 through the group GW 20, and a controller such as a CPU which controls this transceiver.

As shown in FIG. 7, the HSS 40 includes a verification unit 41 which performs the verification as shown at step S6 in FIG. 2. This verification unit 41 can be configured by, for example, a transceiver which conducts communication with the MTC-IWF 50, and a controller such as a CPU which controls this transceiver.

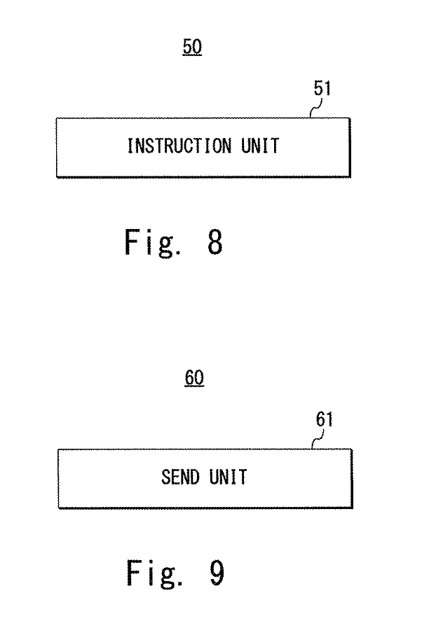

As shown in FIG. 8, the MTC-IWF 50 includes an instruction unit 51. The instruction unit 51 instructs the group GW 20 to broadcast the trigger message, for example by using the indication of trigger method=“broadcast” as shown at step S9 in FIG. 2. This instruction unit 51 can be configured by, for example, a transceiver which conducts communication with the group GW 20 through the MME 30, and a controller such as a CPU which controls this transceiver.

As shown in FIG. 9, the SCS 60 includes a send unit 61. The send unit 61 sends, to the MTC-IWF 50, the trigger message includes the indication of trigger type=“activate group” as shown at step S4 in FIG. 2. This send unit 61 can be configured by, for example, a transceiver which conducts communication with the MTC UE 10 through the core network, and a controller such as a CPU which controls this transceiver.

Note that the present invention is not limited to the above-mentioned exemplary embodiment, and it is obvious that various modifications can be made by those of ordinary skill in the art based on the recitation of the claims.

The whole or part of the exemplary embodiment disclosed above can be described as, but not limited to, the following supplementary notes.

### (Supplementary Note 1)

Introduced a new trigger type “activate group” in the trigger message, which is sent over interface Tsp, T5, and the interface between MME/SGSN/MSC and UE.

### (Supplementary Note 2)

Introduced “broadcast” as a new trigger delivery method.

### (Supplementary Note 3)

Authentication Request can be protected by private group key.

### (Supplementary Note 4)

Introduced trigger field in the broadcasting message to indicate it is to call MTC UE to start Attach procedure.

### (Supplementary Note 5)

New function for HSS of verification to determine whether the external group is valid.

### (Supplementary Note 6)

Included “trigger ID” in Attach Request message.

### (Supplementary Note 7)

Sending the encrypted new group keys in NAS SMC message.

### (Supplementary Note 8)

Or sending the new group keys in Attach Accept message which has NAS security protection.

This application is based upon and claims the benefit of priority from Japanese patent application No. 2012-267255, filed on Dec. 6, 2012, the disclosure of which is incorporated herein in its entirety by reference.

### REFERENCE SIGNS LIST

10, 10_1-10_{—}n MTC UE
11, 31 INCLUSION UNIT
20 GROUP GW
21 ADDITION UNIT
22 PROTECTION UNIT
30 MME
32 CONCATENATION UNIT
33, 61 SEND UNIT
34 ENCRYPTION UNIT
40 HSS
41 VERIFICATION UNIT
50 MTC-IWF
51 INSTRUCTION UNIT
60 SCS

1. A communication system comprising:
a group of MTC (Machine-Type-Communication) devices;
a server that can communicate with the MTC devices; and
a network that relays traffic between the MTC devices and the server,
wherein the server send a trigger message for activating the group to the MTC devices through the network.

2. The communication system according to claim 1, wherein the network includes a first network node that verifies whether or not to transfer the trigger message to the given MTC devices, based on subscription information on the group.

3. The communication system according to claim 2,
wherein the network further includes:
a gateway; and
a second network node that relays traffic between the gateway and the server,
wherein the second network node instructs the gateway to broadcast the trigger message addressed to the group, and
the gateway broadcasts the trigger message in accordance with the instruction.

4. The communication system according to claim 3, wherein the gateway adds, to the trigger message, a field for requesting each of the MTC devices to attach to the network.

5. The communication system according to claim 3,
wherein the network further includes a third network node that protects a group trigger message to be transmitted to each of the MTC devices, by use of a private key for the group.

6. (canceled)

7. The communication system according to claim 5,
wherein the network further includes a fourth network node that includes, in messages addressed to the MTC devices, keys for each of the MTC devices to securely conduct group communication with the network, and
each of the messages comprises a securely protected message indicating that each of the MTC devices is accepted to attach to the network.

8-9. (canceled)

10. A server that can communicate with a group of MTC (Machine-Type-Communication) devices through a network relaying traffic between the MTC devices and the server, the server comprising:
a send unit that sends a trigger message for activating the group to the MTC devices through the network.

11. (canceled)

12. A node included in a network that relays between a group of MTC (Machine-Type-Communication) devices and a server, the node comprising:
a verification unit that verifies whether or not to transfer a trigger message to the given MTC devices based on subscription information on the group, the trigger message being for activating the group and received from the server.

13. (canceled)

14. A node included in a network that relays between a group of MTC (Machine-Type-Communication) devices and a server, the node comprising:
an instruction unit that instructs a gateway to broadcast a trigger message addressed to the group, the gateway serving as a gateway to the network for the MTC devices.

15-31. (canceled)

32. A method for a communication system including a group of MTC (Machine-Type-Communication) devices, a server that can communicate with the MTC devices, and a network that relays traffic between the MTC devices and the server, the method comprising:
sending, by the server, a trigger message for activating the group to the MTC devices through the network.

33. The method according to claim 32, wherein the network includes a first network node, the method further comprising:
verifying, by the first network node, whether or not to transfer the trigger message to the given MTC devices, based on subscription information on the group.

34. The method according to claim 33, wherein the network further includes a gateway, and a second network node that relays traffic between the gateway and the server, the method further comprising:
instructing, by the second network node, the gateway to broadcast the trigger message addressed to the group; and
broadcasting, by the gateway, the trigger message in accordance with the instruction.

35. The method according to claim 34, further comprising:
adding, by the gateway, to the trigger message, a field for requesting each of the MTC devices to attach to the network.

36. The method according to claim 34, wherein the network further includes a third network node, the method comprising:
protecting, by the third network node, a group trigger message to be transmitted to each of the MTC devices, by use of a private key for the group.

37. The method according to claim 36, wherein the network further includes a fourth network node, the method comprising:
including, by the fourth network node, in messages addressed to the MTC devices, keys for each of the MTC devices to securely conduct group communication with the network,
wherein each of the messages comprises a securely protected message indicating that each of the MTC devices is accepted to attach to the network.
